(19) United States
(12) Patent Application Publication
(10) Pub. No.: US 2013/0314533 A1
(43) Pub. Date: Nov. 28, 2013

(54) DATA DERIVING APPARATUS

(71) Applicant: FUJITSU TEN LIMITED, Kobe-shi (JP)

(72) Inventors: Minoru FUJIOKA, Kobe-shi (JP); Shinya NABATAME, Kawasaki (JP)

(73) Assignee: FUJITSU TEN LIMITED, Kobe-shi (JP)

(21) Appl. No.: 13/848,488

(22) Filed: Mar. 21, 2013

(30) Foreign Application Priority Data
May 25, 2012 (JP) 2012-119374

(51) Int. Cl. H04N 7/18

(52) U.S. Cl. CPC H04N 7/18
USPC 348/135

(57) ABSTRACT

A position identifying part identifies positions of mark images in a captured image obtained by capturing an image of two marks by the camera. Then an error deriving part derives an error rate err of an actual image height r′ to a design image height r based on the positions of the two mark images. Moreover, a distortion deriving part derives an actual distortion of the camera based on the error rate err and a distortion characteristic defined in advance from design.

### BACKGROUND OF THE INVENTION

1. Field of the Invention

The invention relates to a technology that derives data relating to a camera.

2. Description of the Background Art

A phenomenon called a distortion in which an image of a subject is distorted in a captured image obtained by a camera, occurs. Especially, in the captured image obtained by a camera using a fish lens, a relatively large distortion occurs.

A characteristic of such distortion in the captured image obtained by a camera (hereinafter referred to as “distortion characteristic”) can be derived by, for example, Zhang's method. The Zhang's method is disclosed in “A flexible new technique for camera calibration” in IEEE Transactions on Pattern Analysis and Machine Intelligence, 22(11): 1330-1334, 2000. In the Zhang's method, a camera captures an image of many marks arrayed in a grid and then a distortion characteristic is derived based on positions of images of the many marks in the captured image.

A distortion characteristic of the camera can be expressed by a relation between an angle of incidence of light from the subject and an image height (a distance from a center of a picture image) of the subject. Such a distortion characteristic of the camera is defined in advance from design. However, an actual distortion characteristic of the camera varies depending on the camera due to, for example, a manufacturing error, and is different from a distortion characteristic in the design.

Recently, a technology that generates a combined image (overhead image) showing surroundings of the vehicle viewed from a virtual point of view by combining plural captured images obtained by plural cameras installed on/in a vehicle, has become popular. In a case of generating such a combined image, a distortion in an image of a subject in the captured image is corrected taking the distortion characteristic into consideration. However, an actual distortion characteristic of a camera is different from a distortion characteristic in design. Therefore, in a case of simply using the data showing the distortion characteristic in design, a distortion of a subject image is not appropriately corrected. As a result, the generated combined image has a problem, for example, where images of a same subject are misaligned at a seam between the captured images.

It is required to derive the actual distortion characteristic of each of the plural cameras by using a method such as the aforementioned Zhang method, to solve such a problem. However, since there are many restrictions on equipment placed in a work area of a vehicle factory, it is difficult to actually place many marks in a grid in such a work area. Therefore, it was required to find a technology that derives an actual distortion characteristic of a camera by using more simple equipment.

### SUMMARY OF THE INVENTION

According to one aspect of the invention, a data deriving apparatus derives data relating to a camera. The apparatus includes a controller configured to: identify positions of two mark images in a captured image of two marks obtained by the camera; derive an error rate of an actual image height of a subject image in the captured image to a design image height based on a first distortion characteristic defined in advance from design of the camera, based on the positions of the two mark images; and derive an actual second distortion characteristic of the camera, based on the error rate and the first distortion characteristic.

Since the actual second distortion characteristic of the camera is derived based on the positions of the two mark images in the captured image, the actual second distortion characteristic of the camera can be derived with relatively simple equipment.

According to another aspect of the invention, the controller derives the error rate based on a result of a comparison of an actual distance between the two marks with a derived distance between the two marks derived based on the positions of the two mark images in the captured image.

The actual second distortion characteristic of the camera can be derived by a relatively simple algorithm.

Moreover, according to another aspect of the invention, the controller obtains an installation parameter relating to installation of the camera, based on the second distortion characteristic and the captured image of the two marks obtained by the camera.

The installation parameter can be obtained with precision by using the actual second distortion characteristic of the camera.

Therefore, the objective of the invention is to derive an actual distortion characteristic of a camera with relatively simple equipment.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates a calibration system including a data deriving apparatus;

FIG. 2 illustrates an external appearance of a position marker;

FIG. 3 illustrates placement of a plurality of cameras and directions in which the cameras capture images;

FIG. 4 illustrates a configuration of a vehicle-mounted apparatus;

FIG. 5 explains a method used when an image combiner generates a combined image;

FIG. 6 illustrates correspondence relation between areas of a projection plane and captured images;

FIG. 7 illustrates an example of a captured image used to generate a combined image:

FIG. 8 illustrates a flowchart of a calibration process;

FIG. 9 illustrates an example of a captured image for the calibration process;

FIG. 10 illustrates a distortion characteristic of a camera;

FIG. 11 illustrates a relation between an error rate and an angle of incidence;

FIG. 12 illustrates a relation between a world coordinate system and a camera coordinate system;

FIG. 13 illustrates a position relation between a camera and two marks;

FIG. 14 illustrates a flowchart of a distortion driving process;

FIG. 15 explains a method of deriving back-calculated image height;

FIG. 16 illustrates an eye vector v₁ and an eye vector v₂;

FIG. 17 illustrates an angle θ₁ and an angle θ₂;

FIG. 18 illustrates an vector T₁ and vector T₂; and

FIG. 19 illustrates a vector T₃.

### DESCRIPTION OF THE EMBODIMENTS

An embodiment of the invention is hereinafter explained with reference to the drawings.

<1. System Outline>

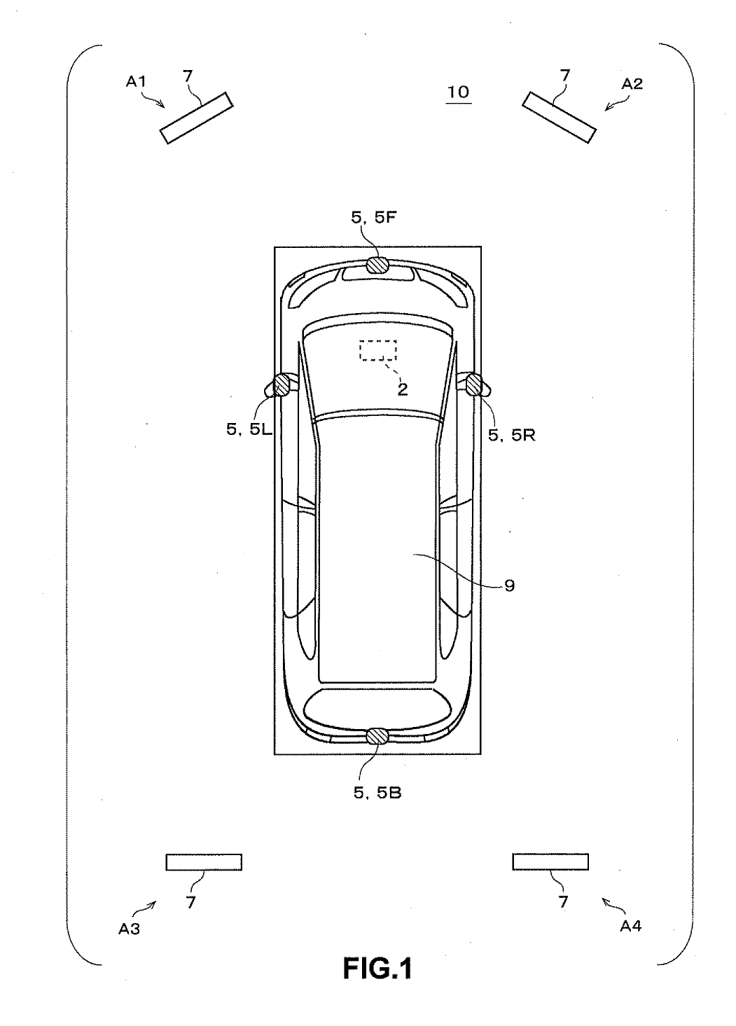

FIG. 1 illustrates a calibration system 10 including a data deriving apparatus that is this embodiment. The calibration system 10 is used for obtaining data of each of a plurality of cameras 5 installed on a vehicle 9 (a car in this embodiment). The calibration system 10 performs a calibration process to obtain distortion data (hereinafter referred to as “actual data”) that shows an actual distortion characteristic of each of the cameras 5 and to obtain an installation parameter relating to installation of each of the cameras 5.

The actual distortion characteristic of each of the cameras 5 is different from a distortion characteristic defined in advance from design (hereinafter referred to as “design characteristic”). Therefore, the calibration system 10 obtains the actual data showing the actual distortion characteristics of the cameras 5. Moreover, an optical axis of each of the cameras 5 is slightly different from a direction defined from design. Therefore, the calibration system 10 obtains the installation parameter relating to the installation of each of the cameras 5, such as a horizontal angle, a vertically-tilted angle, and a rotated angle.

The calibration system 10 includes the plurality of cameras 5 to be installed on the vehicle 9, a vehicle-mounted apparatus 2, and four position markers 7 located separately from the vehicle 9. The four position markers 7 are located in predetermined positions in a work area of a vehicle factory, a vehicle maintenance shop or another place where the calibration process is performed.

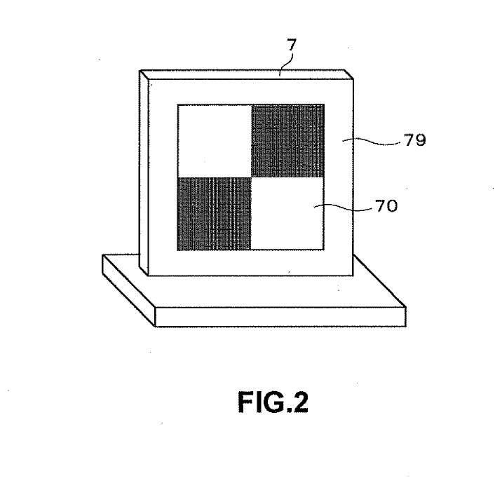

As shown in FIG. 2, each of the four position markers 7 is in a three-dimensional (3D) shape so that each position marker 7 can stand upright. Each of the position markers 7 includes a board-like member 79, such as an upright standing plastic board. A mark 70 having a predetermined pattern is formed on a principle surface, facing the vehicle 9, of the board-like member 79. The pattern of the mark 70 is, for example, a checkers design having two color squares arranged alternately. One of the two colors of the checkers design is relatively dark (e.g. black) and the other is relatively bright (e.g. white).

In a case of performing the calibration process, as shown in FIG. 1, the vehicle 9 is substantially accurately located at a predetermined position in the work area by, for example, a correct positioning apparatus. Thus, relative positions of the four position markers 7 to the vehicle 9 are unvaried. The four position markers 7 are respectively placed in regions A1, A2, A3, and A4 that correspond to a left region in front of the vehicle 9, a right region in front of the vehicle 9, a left region behind the vehicle 9, and a right region behind the vehicle 9, respectively. In a state where the position markers 7 are placed in the regions, the cameras 5 installed on the vehicle 9 capture images of surroundings of the vehicle 9 including the position markers 7.

Based on the captured images obtained in a manner mentioned above, the vehicle-mounted apparatus 2 functions as a data deriving apparatus that derives data of the cameras 5. Based on the captured images, the vehicle-mounted apparatus 2 derives the actual data showing actual distortion characteristics of the cameras 5 and the installation parameters of the cameras 5. The vehicle-mounted apparatus 2 identifies positions of images of the marks 70 included in the captured images and then derives the actual data and the installation parameters based on the positions of the images of the marks 70.

Such a calibration process is performed when the plurality of cameras 5 get installed on the vehicle 9. The actual data and the installation parameters obtained in the calibration process are stored in the vehicle-mounted apparatus 2 and are used in an image processing performed by the vehicle-mounted apparatus 2 after the storage.

<2. Vehicle-Mounted Camera>

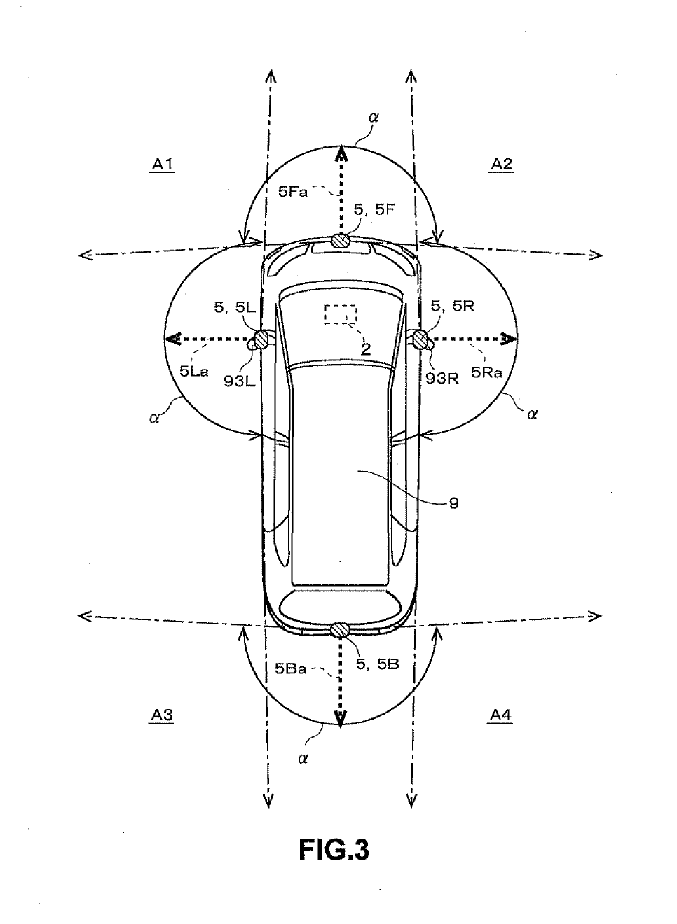

FIG. 3 illustrates placement of the plurality of cameras 5 and directions in which the cameras capture the images. Each of the plurality of cameras 5 includes a lens and an image sensor to electronically obtain the captured image showing the surroundings of the vehicle 9. Each of the cameras 5 is provided at an appropriate place of the vehicle 9, separately from the vehicle-mounted apparatus 2, and inputs the obtained captured image to the vehicle-mounted apparatus 2.

The plurality of cameras 5 includes a front camera 5F, a back camera SB, a left side camera 5L, and a right side camera SR. Each of these four cameras 5F, 5B, 5L, and 5R is provided on a position different from one another and captures the image of the surroundings of the vehicle 9 in a direction different from one another.

The front camera 5F is provided in a vicinity of a horizontal center of a front end of the vehicle 9, having an optical axis 5Fa in a front direction (a straight ahead direction) of the vehicle 9. The back camera 5B is provided in a vicinity of a horizontal center of a rear end of the vehicle 9, having an optical axis 5Ba in a back direction (a direction opposite to the straight ahead direction) of the vehicle 9. The left side camera 5L is provided on a left side mirror 93L of the vehicle 9, having an optical axis 5La in a left direction (a direction orthogonal to the straight ahead direction) of the vehicle 9. Moreover, the right side camera 5R is provided on a right side mirror 93R of the vehicle 9, having an optical axis 5Ra in a right direction (a direction orthogonal to the straight ahead direction) of the vehicle 9.

A fish-eye lens is used for a lens of each of the plurality of cameras 5, and each of the cameras 5 has an angle of view a of 180 degrees or more. Therefore, it is possible to capture images covering 360-degree surroundings of the vehicle 9 by using the four cameras 5F, 5B, 5L, and 5R. Each of the regions A1, A2, A3, and A4 of the left region in front of the vehicle 9, the right region in front of the vehicle 9, the left region behind the vehicle 9, and the right region behind the vehicle 9 is a photographic subject redundantly of two of the four cameras 5. Each of the four position markers 7 is placed in each of the four regions A1, A2, A3, and A4 that is the photographic subject of two of the cameras 5 as mentioned above. (Refer to FIG. 1.) Thus, each of the four cameras 5 can capture an image of the marks 70 on two position markers 7.

<3. Vehicle-Mounted Apparatus>

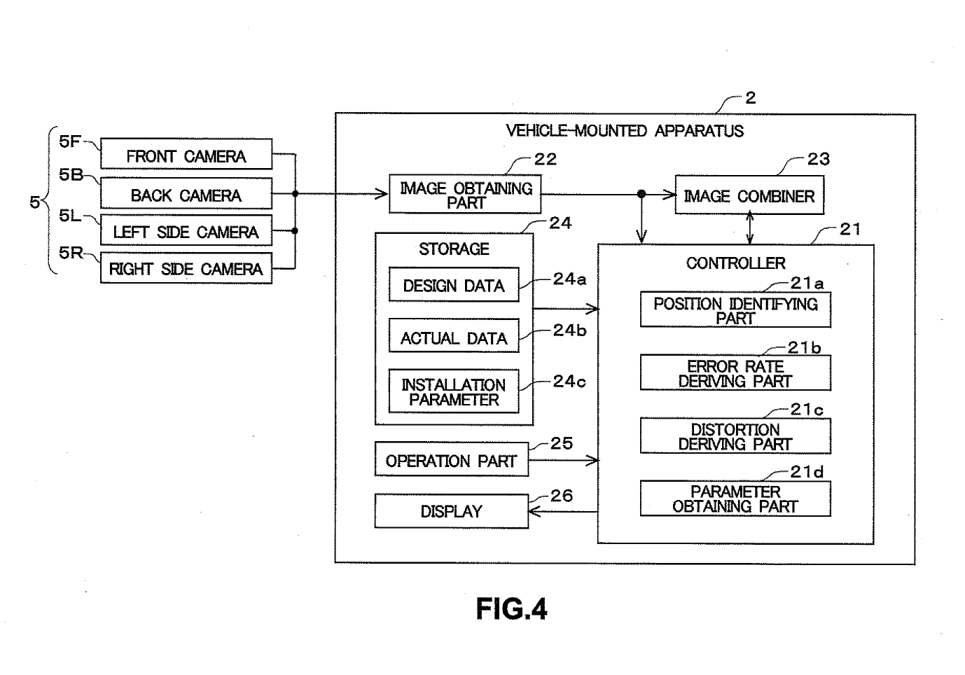

FIG. 4 mainly illustrates a configuration of the vehicle-mounted apparatus 2. As shown in FIG. 4, the vehicle-mounted apparatus 2 is communicably connected to the four cameras 5. The vehicle-mounted apparatus 2 includes a function of generating a combined image showing the surroundings of the vehicle 9 viewed from a virtual point of view by combining four captured images respectively obtained by the four cameras 5 and of displaying the combined image. The vehicle-mounted apparatus 2 uses the actual data and the installation parameters obtained in the calibration process when generating the combined image.

The vehicle-mounted apparatus 2 includes a display 26, an operation part 25, an image obtaining part 22, an image combiner 23, a storage 24, and a controller 21.

The display 26 is a thin display apparatus including, for example, a liquid crystal panel, and shows a variety of information and images. The operation part 25 is, for example, an operation button that receives a user operation. When a user operates the operation part 25, a signal representing a content of the operation is input to the controller 21.

The image obtaining part 22 obtains the captured images obtained by the four cameras 5, from the four cameras 5. The image obtaining part 22 includes a basic image processing function such as A/D conversion function that converts an analog captured image into a digital captured image. The image obtaining part 22 performs a predetermined image processing on the obtained captured images and inputs the processed captured images to the image combiner 23 and the controller 21.

The image combiner 23 is, for example, a hardware circuit, and performs a predetermined image processing. The image combiner 23 generates the combined image (overhead view) showing the surroundings of the vehicle 9 viewed from an arbitrary virtual point of view by using the four captured images respectively captured by the four cameras 5. A method that the image combiner 23 uses to generate the combined image viewed from the virtual point of view will be described later.

The storage 24 is, for example, a nonvolatile memory such as a flash memory, and stores various types of information. The storage 24 stores design data 24a, actual data 24b, and a installation parameter 24c. Moreover, the storage 24 stores a program serving as firmware of the vehicle-mounted apparatus 2.

The design data 24a is distortion data showing the design characteristic of the cameras 5. On the other hand, the actual data 24b is distortion data showing the actual distortion characteristic of each of the cameras 5. The design data 24a is common data for all the four cameras 5F, 5B, 5L, and 5R. However, the actual data 24b varies depending on each of the cameras 5. The actual data 24b is obtained in the calibration process based on the design data 24a. Therefore, before the calibration process, the design data 24a is stored in the storage 24, but the actual data 24b is not stored.

Moreover, the installation parameter 24c is a parameter relating to the installation of each of the cameras 5. The installation parameter 24c includes a parameter that indicates a direction of the optical axis of each of the cameras 5 such as the horizontal angle, the vertically-tilted angle, and the rotated angle. The installation parameter 24c varies depending on each of the cameras 5. The installation parameter 24c is also obtained in the calibration process. Therefore, before the calibration process, the installation parameter 24c is not stored in the storage 24.

The storage 24 stores the actual data 24b and the installation parameter 24c corresponding to each of the four cameras 5F, 5B, 5L, and 5R. The actual data 24b and the installation parameter 24c are used when the image combiner 23 generates the combined image.

The controller 21 is a microcomputer that comprehensively controls the entire vehicle-mounted apparatus 2. The controller 21 includes a CPU, a RAM, a ROM, etc. Various functions of the controller 21 are implemented by arithmetic processing performed by the CPU in accordance with a program stored in the storage 24. A position identifying part 21a, an error rate deriving part 21b, a distortion deriving part 21c, and a parameter obtaining part 21d, shown in FIG. 4, are a part of function parts implemented by the arithmetic processing performed by the CPU in accordance with a program. These function parts implement a process relating to the calibration process. Details of each of the function parts will be described later.

<4. Generation of the Combined Image>

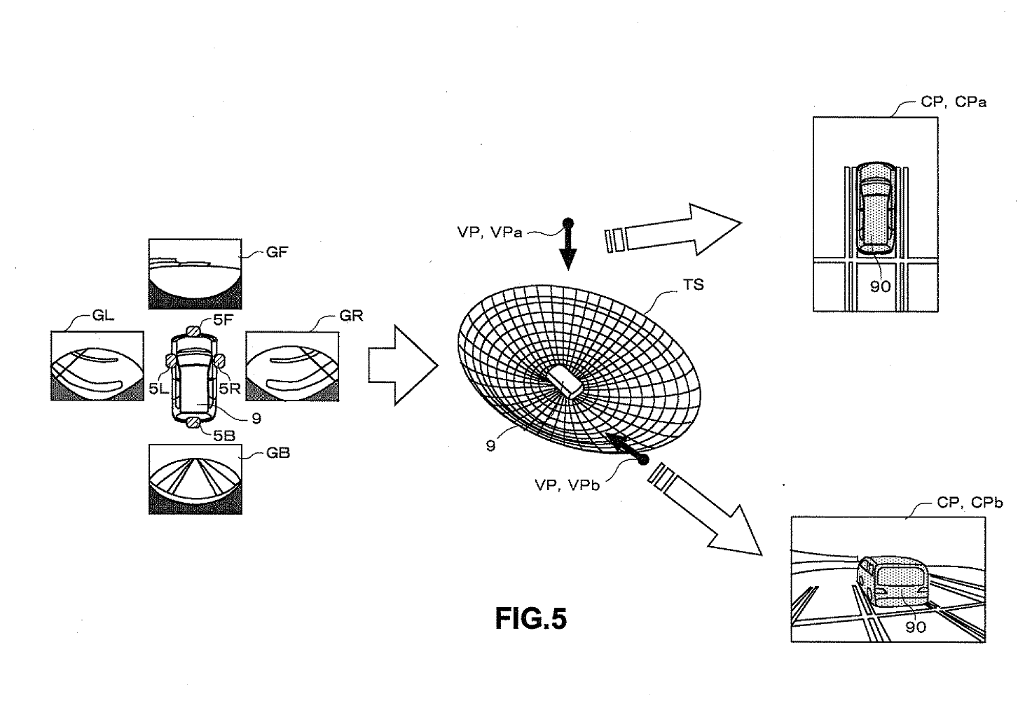

Next explained is a method used when the image combiner 23 generates the combined image. FIG. 5 explains the method used when the image combiner 23 generates the combined image.

When capturing images, the front camera 5F, the back camera 513, the left side camera 5L, and the right side camera 5R of the vehicle-mounted apparatus 2 obtain four captured images GF, GB, GL, and GR respectively that show regions in front of, behind, on left of and on right of the vehicle 9 respectively. Images of subjects existing in the 360-degree surroundings of the vehicle 9 are included in the four captured images GF, GB, GL, and GR.

The image combiner 23 projects data (values of individual pixels) included in the four captured images GF, GB, GL, and GR onto a projection plane TS that is a 3D curved plane in a virtual 3D space. The projection plane TS is substantially shaped like a hemisphere (a bowl). A center area of the projection plane TS (a bottom of the bowl) is defined as an area for the vehicle 9. On the other hand, each of areas other than the center area of the projection plane TS corresponds to one of the captured images GF, GB, GL, and GR. The image combiner 23 projects the data included in the captured images GF, GB, GL, and GR onto the areas other than the center area.

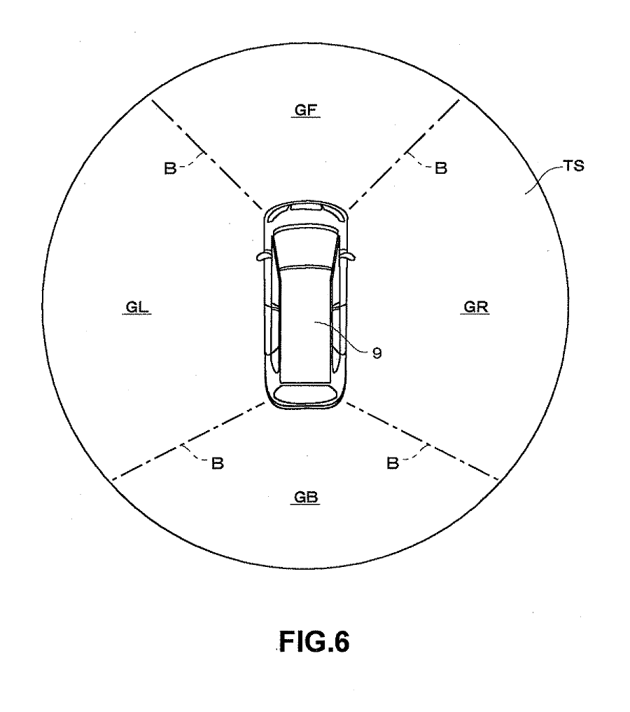

As shown in FIG. 6, the image combiner 23 projects the data included in the captured image GF obtained by the front camera 5F onto an area of the projection plane TS corresponding to the region in front of the vehicle 9. The image combiner 23 projects the data included in the captured image GB obtained by the back camera 5B onto an area of the projection plane TS corresponding to the region behind the vehicle 9. The image combiner 23 projects the data included in the captured image GL obtained by the left side camera 5L onto an area of the projection plane TS corresponding to the left side region of the vehicle 9. The image combiner 23 projects the data included in the captured image GR obtained by the right side camera 5R onto an area of the projection plane TS corresponding to the right side region of the vehicle 9.

In reference back to FIG. 5, after projecting the data onto each area of the projection plane TS, the image combiner 23 create a virtual polygonal model showing the vehicle 9 in a 3D form. The model of the vehicle 9 is placed in the center area of the substantially hemisphere projection plane TS, defined as the area for the vehicle 9 in the 3D space in which the projection plane TS is set.

Next, the image combiner 23 sets a virtual point of view VP to the 3D space. The image combiner 23 is capable of setting the virtual point of view VP in an arbitrary direction of view at an arbitrary position in the 3D space. Then, the image combiner 23 clips out, as an image, from the projection plane TS, an area within a range of a predetermined angle of view from the set virtual point of view VP. Moreover, the image combiner 23 renders the polygonal model in accordance with the set virtual point of view VP and then superimposes a two-dimensional vehicle image 90, which is a result of the rendering, on the clipped-out image. Thus, the image combiner 23 generates a combined image CP showing the vehicle 9 and a vicinity region of the vehicle 9 viewed from the virtual point of view VP.

For example, as shown in FIG. 5, in a case where a virtual point of view VPa is set to look straight down from a point of view positioning straight above the vehicle 9, the combined image CPa is generated to show a overhead view of the vehicle 9 and the vicinity region of the vehicle 9. Moreover, in a case where a virtual point of view VPb is set to look ahead of the vehicle 9 from a point of view positioning in a left side behind the vehicle 9, a combined image CPb is generated to show a sweeping view of the entire vicinity region of the vehicle 9, including the vehicle 9 and the vicinity region of the vehicle 9, viewed from a left side behind the vehicle 9.

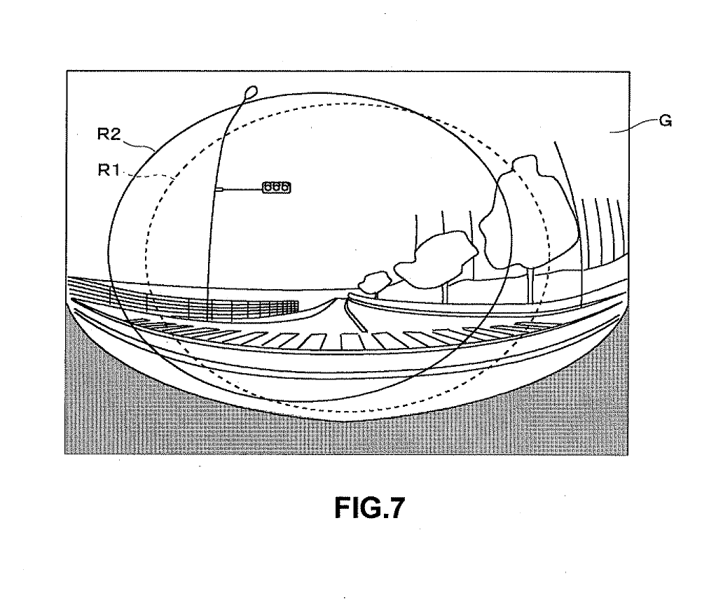

FIG. 7 illustrates an example of a captured image G used to generate such a combined image CP. A fish-eye lens is used for the lenses of the cameras 5. Therefore, as shown in FIG. 7, images of subjects (hereinafter referred to as “subject image(s)”) are distorted. Thus, the image combiner 23 corrects distortions of the subject images included in the four captured images GF, FB, GL and GR, taking into consideration distortion characteristics of the four cameras 5, before projecting the data onto the projection plane TS.

As mentioned above, the actual distortion characteristic of each of the cameras 5 is different from the design characteristic. Therefore, if the design data 24a showing the design characteristic is simply used to correct the distortions of the subject images, the distortions of the subject images are not corrected appropriately. As a result, a problem where images of a same subject are misaligned at a seam B (refer to FIG. 6) between the captured images projected on the projection plane TS, is caused. Therefore, the image combiner 23 uses the actual data 24b showing the actual distortion characteristic of the camera 5 that has obtained the captured image G, to correct the distortions of the subject images in the captured image G.

Moreover, a target region in the captured image G including data to be projected on the projection plane TS varies in accordance with an error caused during installation of the camera 5 that has obtained the captured image G. Therefore, the image combiner 23 corrects the target region that is projected on the projection plane TS, using the installation parameters 24c (the horizontal angle, the vertically-tilted angle, the rotated angle, etc.) of the camera 5.

If there is no error caused during the installation of the camera 5 that has obtained the captured image G shown in FIG. 7, the target region including the data to be projected on the projection plane TS is a region R1, a default. Since an error is normally caused during the installation of the camera 5, the image combiner 23 corrects the target region that is projected on the projection plane TS, from the region R1 to a region R2, based on the installation parameter 24c of the camera 5. Then the image combiner 23 projects the data included in the region R2 onto the projection plane TS.

In the manner mentioned above, the image combiner 23 can generate an appropriate combined image CP by using the actual data 24b and the installation parameters 24c of the camera 5 when generating the combined image CP.

<5. Calibration Process>

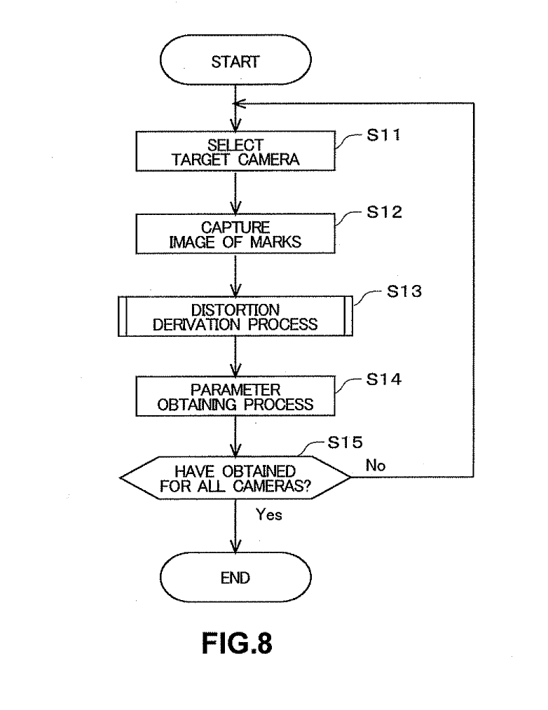

Next explained is the calibration process for obtaining the actual data 24b and the installation parameters 24c of the cameras 5. The calibration process is performed by an operator who implements a predetermined operation with the operation part 25 in a state where the vehicle 9 is located in the predetermined position in the work area having the four position markers 7 located beforehand, as shown in FIG. 1. FIG. 8 is illustrates a flowchart of the calibration process. A flow of the calibration process is hereinafter explained.

First, the controller 21 selects one from amongst the four cameras 5 as “a target camera 5” for the process (a step S11). The actual data 24b and the installation parameters 24c of the target camera 5 are obtained in steps from a step S12 to a step S14 in the process.

In the step S12, the target camera 5 obtains the captured image by capturing an image of the vicinity region of the vehicle 9 including the marks 70 on the two position markers 7.

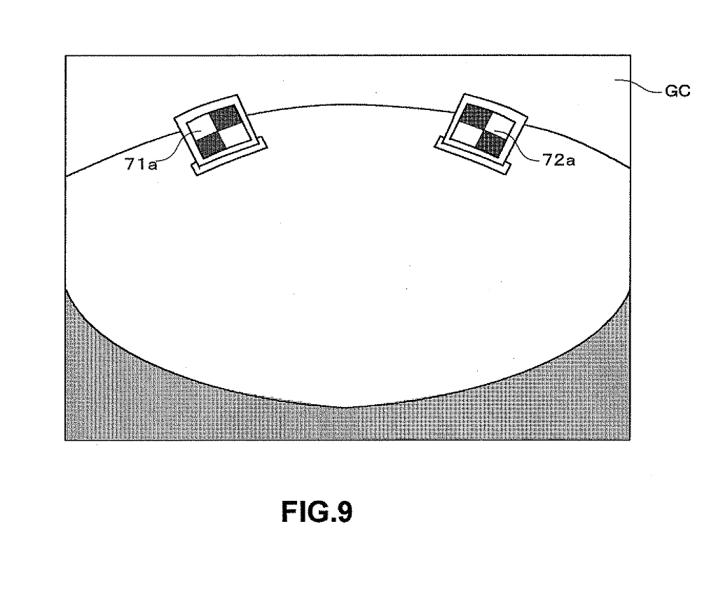

FIG. 9 illustrates an example of a captured image GC obtained in the manner mentioned above for the calibration process. As shown in FIG. 9, images 71a and 72a of the two marks 70 (hereinafter referred to as “mark image”) are included in the captured image GC.

Next, in a step S13, a distortion derivation process is performed to derive the actual data 24b showing the actual distortion characteristic of the target camera 5. The actual data 24b is derived in the distortion derivation process, based on positions of the two mark images 71a and 72a included in the captured image GC. The distortion derivation process is performed by the position identifying part 21a, the error rate deriving part 21b, and the distortion deriving part 21c. Details performed by the parts will be explained later. The actual data 24b obtained in the distortion derivation process is associated with the target camera 5 and is stored in the storage 24.

Next, in the step S14, the parameter obtaining part 21d performs a parameter obtaining process to obtain the installation parameters 24c relating to installation of the target camera 5. The parameter obtaining part 21d first corrects distortions of subject images in the captured image GC, using the actual data 24b obtained in the step S13. Then the parameter obtaining part 21d derives the installation parameters 24c of the target camera 5 based on the positions of the two mark images 71a and 72a included in the captured image GC, by using a common method such as a method disclosed in Japanese Patent Application Laid-open Publication No. 4803449. For example, the parameter obtaining part 21d can derive the horizontal angle based on horizontal positions of the two mark images 71a and 72a in the captured image GC, the vertically-tilted angle based on vertical positions of the two mark images 71a and 72a in the captured image GC, and the rotated angle based on a difference in height between the two mark images 71a and 72a in the captured image GC.

As mentioned above, after correcting the distortions of the subject images in the captured image GC by using the actual data 24b showing the actual distortion characteristic of the target camera 5, the parameter obtaining part 21d derived the installation parameters 24c based on the captured image GC. Therefore, the installation parameters 24c can be obtained with precision. The installation parameters 24c obtained in the parameter obtaining process are associated with the target camera 5 and are stored in the storage 24.

When the parameter obtaining process is completed, the controller 21 determines whether or not the actual data 24b and the installation parameters 24c of all the four cameras 5 have been derived. If there is any camera 5 of which the actual data 24b and the installation parameters 24c have not been derived (No in a step S15), the camera 5 that has not been set as the target camera 5 is set as a new target camera 5, and the process mentioned above is repeated. By repeating the process mentioned above, the actual data 24b and the installation parameters 24c of all the four cameras 5 are derived. When the actual data 24b and the installation parameters 24c of all the four cameras 5 are derived (Yes in the step S15), the calibration process ends.

<6. Distortion Derivation Process>

Next, the distortion derivation process in the step S13 is explained in detail. First explained is a relation between the design data 24a showing the design characterisitic and the actual data 24b showing the actual distortion of the camera 5.

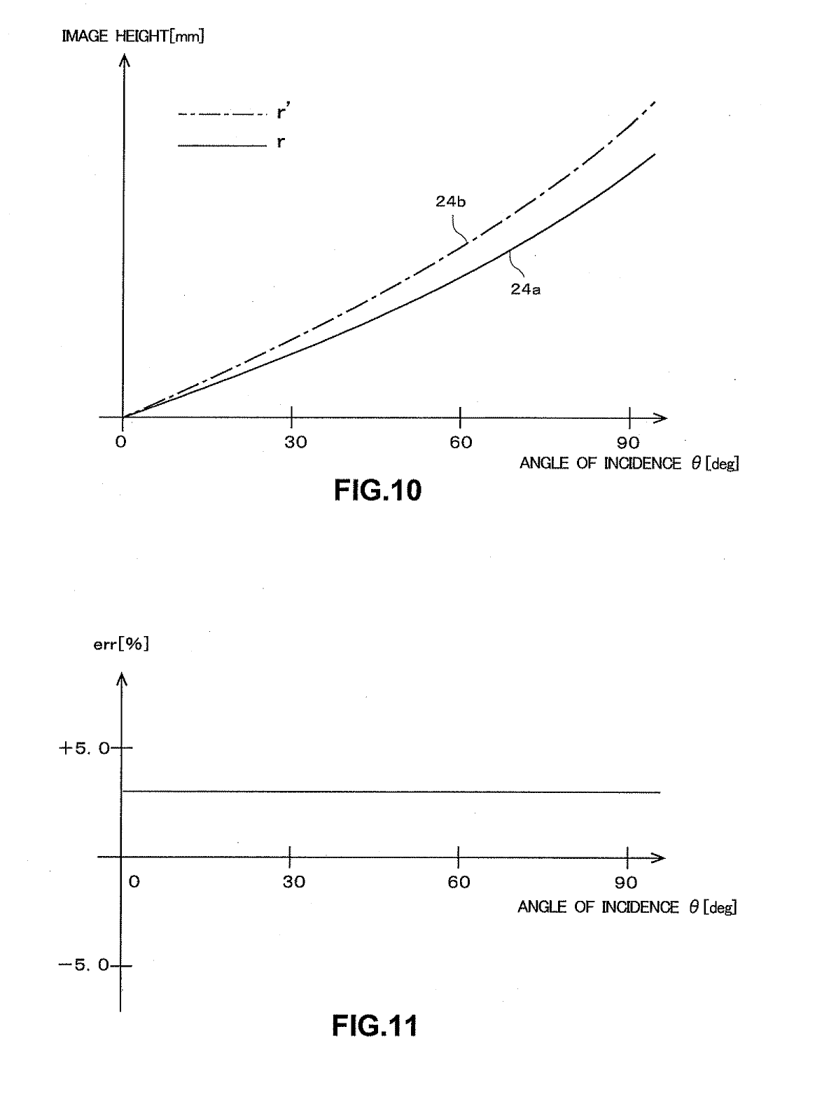

FIG. 10 illustrates the distortion characteristic of the camera 5. FIG. 10 illustrates the distortion characteristic from a relation between an angle of incidence θ (deg) of light from a subject and an image height (mm) of the subject image in a captured image. Two curves, shown in FIG. 10, each of which shows the relation between the angle of incidence θ and the image height, represent the design data 24a and the actual data 24b. The design data 24a is represented by a solid-line curve representing an image height r based on the design characteristic (hereinafter referred to as “design image height”). On the other hand, the actual data 24b is represented by a dashed-dotted line curve representing an actual image height r′ in the captured image (hereinafter referred to as “actual image height”).

As shown in FIG. 10, there is an error between the design image height r and the actual image height r′. The error (r′−r) of the actual image height r′ to the design image height r becomes larger as the angle of incidence θ becomes larger. Therefore, as a subject is located more away from the optical axis of the camera 5, the subject image of the subject is more affected by a difference between such distortion characteristics.

An error rate err (%) of the actual image height r′ to the design image height r is herein defined by a following mathematical formula 1.

$$err = \frac{{r}^{′} - r}{r} 100 \qquad [ Mathematical formula 1 ]$$

Moreover, when f represents a focal length of the camera 5, the design image height r is defined by, for example, a following mathematical formula 2.

r=2f·tan(θ/2) [Mathematical formula 2]

On the other hand, the actual distortion characteristic is different from the design characteristic due to a manufacturing error relating to a distance (equal to the focal length f) between the lens of the camera 5 and the image sensor. Therefore, when k represents an error of the focal length f, the actual image height r′ can be represented by a following mathematical formula 3.

r′=2(f+k)·tan(θ/2) [Mathematical formula 3]

Thus, the error rate err of the image height represented by the mathematical formula 1 does not depend on the angle of incidence θ and does not vary as shown in FIG. 11. The error rate err is a value, for example, in a range from −5.0(%) to 5.0(%). In the distortion derivation process, the error rate deriving part 21b first derives the error rate err, and then the distortion deriving part 21c derives the actual data 24b based on the error rate err and the design data 24a.

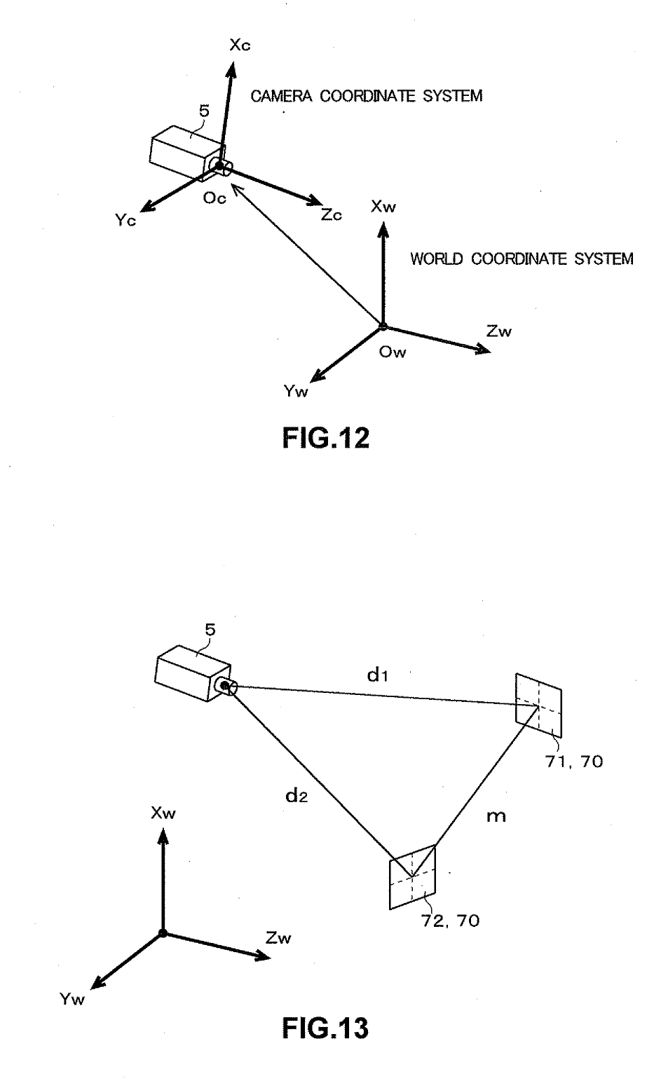

Moreover, in the distortion derivation process, a camera coordinate system set based on the target camera 5 is used. FIG. 12 illustrates a relation between a world coordinate system and the camera coordinate system. The world coordinate system is a 3D Cartesian coordinate system having an Xw axis, a Yw axis, and a Zw axis and is set based on the vehicle 9. On the other hand, the camera coordinate system is a 3D Cartesian coordinate system having an Xc axis, a Ye axis, and a Zc axis and is set based on the target camera 5.

An origin Ow of the world coordinate system is different from an origin Oc of the camera coordinate system. Furthermore, generally, directions of the individual axes of the world coordinate system are different from directions of the individual axes of the camera coordinate system. The origin Oc of the camera coordinate system in the world coordinate system (i.e. a position of the target camera 5 relative to the vehicle 9) is known. In addition, the Zc axis of the camera coordinate system is directed along the optical axis of the target camera 5.

FIG. 13 illustrates a position relation between the target camera 5 and two marks 70 that are photographic subjects of the target camera 5. As shown in FIG. 13, the mark 71 is located on a left side and the mark 72 is located on a right side of the target camera 5 when being viewed from the target camera 5.

As mentioned above, the position markers 7 are located at the predetermined positions and the positions of the position markers 7 relative to the vehicle 9 are unvaried. Therefore, coordinate positions of the marks 71 and 72 in the world coordinate system are known. Therefore, a distance d₁ from the target camera 5 to the mark 71 on the left side, a distance d₂ from the target camera 5 to the mark 72 on the right side, an actual distance m between the mark 71 and the mark 72 can be derived from three coordinate positions of the target camera 5, the mark 71 and the mark 72 in the world coordinate system. The distances d₁, d₂, and m are stored in the storage 24 beforehand and are used in the distortion derivation process. However, the distances d₁, d₂ and m may be derived in a step in the distortion derivation process based on the three coordinate positions.

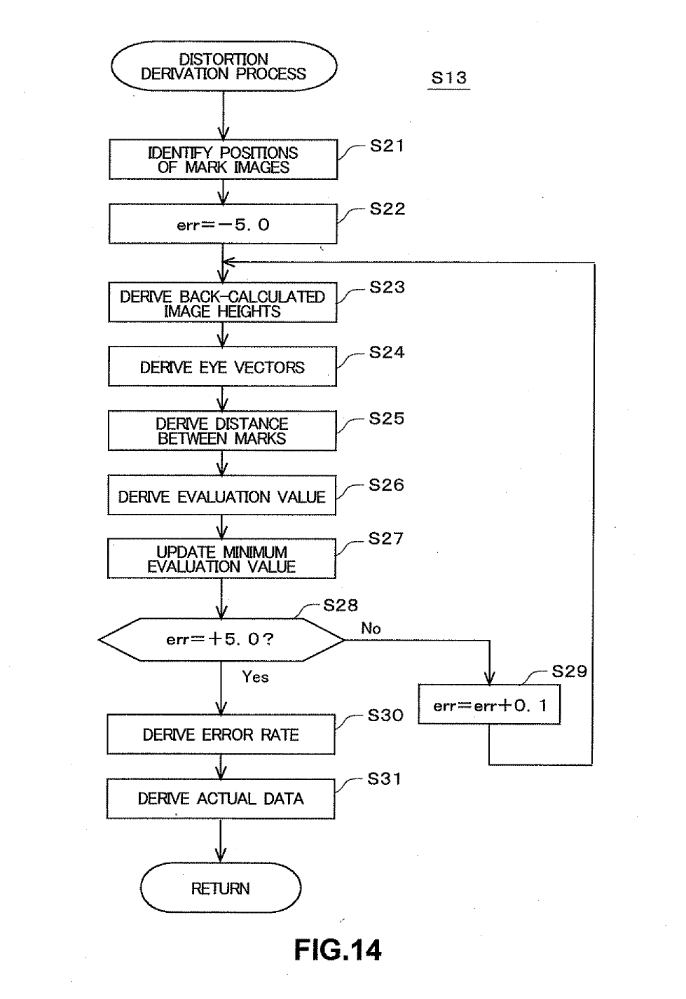

FIG. 14 illustrates flowchart of the distortion derivation process (the step S13 shown in FIG. 8). The flow of the distortion derivation process is explained below. When the process starts, the captured image GC including the two mark images 71a and 72a have been obtained by the target camera 5. Moreover, the design data 24a, the distances d₁, d₂ and m are stored in the storage 24.

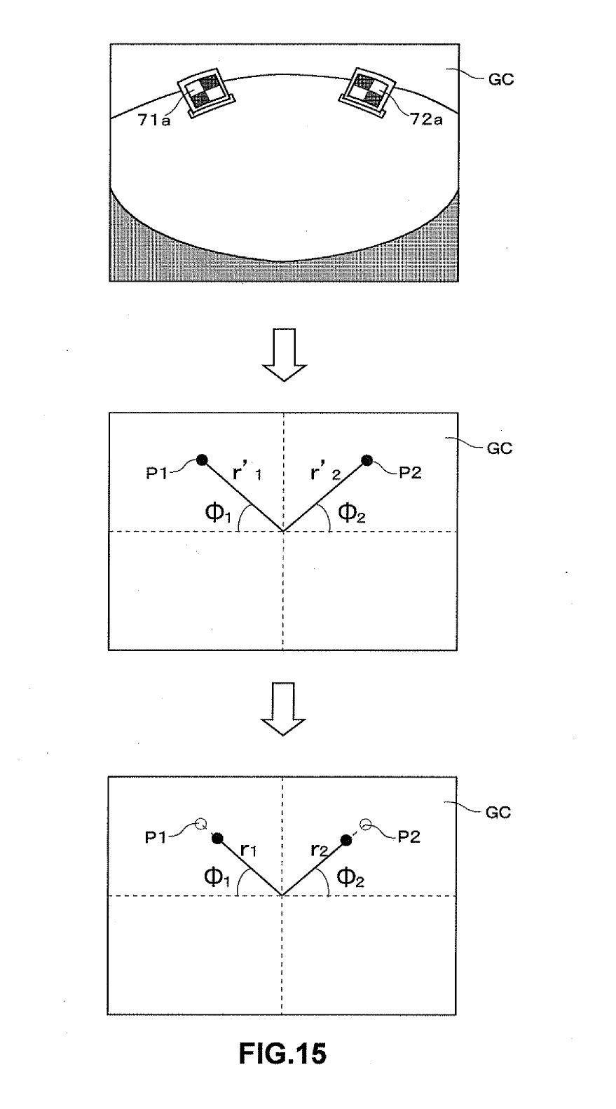

First, the position identifying part 21a identifies positions of the two mark images 71a and 72a in the captured image GC (a step S 21). The position identifying part 21a detects the positions of the two mark images 71a and 72a in the captured image GC like an upper drawing in FIG. 15, by using a well-known corner detection method such as Harris operator. Then, as shown in a mid drawing in FIG. 15, the position identifying part 21a identifies positions P1 and P2 that are center points (intersection point at which lines dividing the two colors in the checkers design intersect each other) of the two mark images 71a and 72a, respectively, in the captured image GC.

Next, the error rate deriving part 21b derives the error rate err based on the positions P1 and P2 of the two mark images 71a and 72a in the captured image GC. The error rate deriving part 21b sets a temporary value to the error rate err to be derived in this process. Then the error rate deriving part 21b derives an evaluation value E by performing a series of steps from a step S23 to a S27, using the temporary value set to the error rate err.

The error rate deriving part 21b changes the temporary value set to the error rate err (%) by 0.1 in a range from −5.0 to +5.0 (steps S22, S28, and S29). Every time when changing the temporary value for the error rate err, the error rate deriving part 21b repeats the series of the steps from the step S23 to S27. Thus, the error rate deriving part 21b derives the evaluation value E per the temporary value set to the error rate err.

In the step S23, the design image height r for each of the two mark images 71a and 72a is derived by using the error rate en for which temporary value has been set.

First, by deriving distances from an image center (a position of the optical axis) of the captured image GC to the respective positions P1 and P2 identified in the step S21, as shown in the mid drawing in FIG. 15, actual image heights r′₁ and r′₂ of the two respective marks 71a and 72a in the captured image GC are derived. The actual image heights r′₁ and r′₂ are values including errors from the design image height r.

Therefore, as shown in the lower drawing in FIG. 15, the design image heights r₁ and r₂, not including errors, of the two respective mark images 71a and 72a are back-calculated based on the temporary value for the error rate err and the actual image heights r′₁ and r′₂. The design image height back-calculated in the manner mentioned above is hereinafter referred to as “back-calculated image height.” The back-calculated image heights r₁ and r₂ can be derived by a following mathematical formula 4 created by modifying the mathematical formula 1.

$$r = \frac{100}{100 = err} {r}^{′} \qquad [ Mathematical formula 4 ]$$

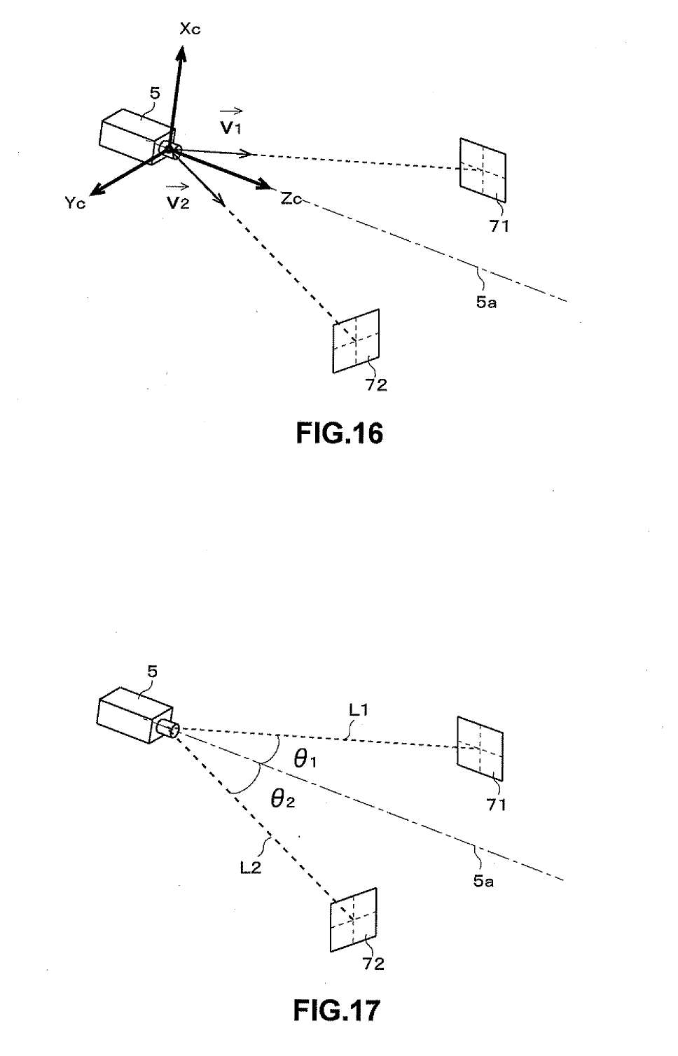

Next, in a step S24 (refer to FIG. 14), eye vectors v₁ and v₂ that are unit vectors of directions from the target camera 5 to the two respective marks 71 and 72 in the camera coordinate system, as shown in FIG. 16, are derived.

First, in reference to the design data 24a (the solid-line curve in FIG. 10), an angle of incidence θ₁ of light from the mark 71 is derived based on the back-calculated image height r₁ of the mark 71 on the left side. Similarly, an angle of incidence θ₂ of light from the mark 72 is derived based on the back-calculated image height r₂ of the mark 72 on the right side. Thus, as shown in FIG. 17, the angle θ₁ between an optical axis 5a of the target camera 5 and a straight line L1 from the target camera 5 to the mark 71, and the angle θ₂ between the optical axis 5a of the target camera 5 and a straight line L2 from the target camera 5 to the mark 72, are derived.

In the captured image GC, herein, Φ₁ is an angle between a horizontal line and a straight line from the image center to the position P1, and Φ₂ is an angle between the horizontal line and a straight line from the image center to the position P2 (refer to FIG. 15).

As mentioned above, the optical axis 5a of the target camera 5 is directed along the Zc axis in the camera coordinate system, and the position of the target camera 5 is the origin of the camera coordinate system. Therefore, as shown in a following mathematical formula 5, the eye vector v₁ (refer to FIG. 16) that is the unit vector of a direction from the target camera 5 to the mark 71 on the left side can be derived based on the angle θ₁ and the angle Φ₁. Moreover, the eye vector v₂ that is the unit vector of a direction from the target camera 5 to the mark 72 on the right side can be derived based on the angle θ₂ and the angle Φ₂.

\vec{v}₁=(sin θ₁·sin Φ₁, sin θ₁·cos Φ₁, cos θ₁)

\vec{v}₂=(sin θ₂·sin Φ₂, sin θ₂·cos Φ₂, cos θ₂) [Mathematical formula 5]

Next, in a step S25 (refer to FIG. 14), a distance between the two marks 71 and 72 is derived.

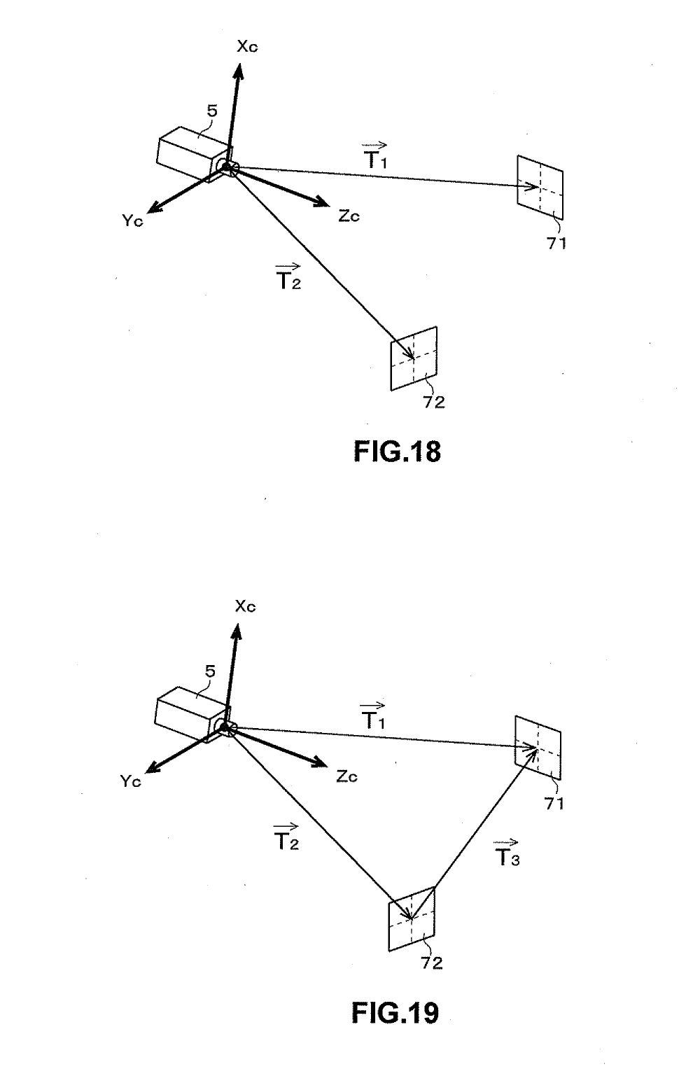

First, as shown in FIG. 18, a vector T₁ starting from the target camera 5 and ending at the mark 71 on the left side and a vector T₂ starting from the target camera 5 and ending at the mark 72 on the right side are derived. As shown by a mathematical formula 6 below, the vector T₁ is derived based on the eye vector v₁ and the distance d₁ from the target camera 5 to the mark 71 on the left side. Moreover, the vector T₂ is derived based on the eye vector v₂ and the distance d₂ from the target camera 5 to the mark 72 on the right side.

\vec{T}₁=d₁·\vec{v}₁

\vec{T}₂=d₂√\vec{v}₂ [Mathematical formula 6]

Then, a vector T₃, shown in FIG. 19, starting from the mark 72 on the right side and ending at the mark 71 on the left side is derived by a mathematical formula 7, by using the vector T₁ and the vector T₂.

\vec{T}₃=\vec{T}₁−\vec{T}₂ [Mathematical formula 7]

Moreover, a length of the vector T₃ is derived as a distance M between the two marks 71 and 72 (hereinafter referred to as “derived distance”) by a mathematical formula 8.

M=∥\vec{T}₃∥ [Mathematical formula 8]

Next, in a step S26 (refer to FIG. 14), the derived distance M derived in the manner mentioned above based on the temporary value for the error rate err is compared to the actual distance m between the two marks 71 and 72, and then a result of the comparison is derived as the evaluation value E. Concretely, an absolute value of a difference between the derived distance M and the actual distance m is derived as the evaluation value E by a mathematical formula 9.

E=|M−m|

The evaluation value E represents an accuracy level of the temporary value set to the error rate err. The smaller the evaluation value E is (i.e. the smaller the difference between the derived distance M and the actual distance m is), the closer to an actual error rate err the temporary value is.

Next, in a step S27, the evaluation value E derived for a current temporary value for the error rate err is compared to a minimum evaluation value among the evaluation values E derived before. In a case where the current evaluation value E is smaller than the minimum evaluation value among the evaluation values E derived before, the minimum evaluation value is updated to set the current evaluation value E as a new minimum evaluation value.

The series of the steps from the S23 to the S27 are repeated. In a case where the process relating to all the temporary values to be set to the error rate err is completed (Yes in the step S28), the temporary value corresponding to the minimum evaluation value E at that time is a closest to the actual error rate err. Therefore, the error rate deriving part 21b derives the temporary value as the actual error rate err (a step S30).

When the error rate deriving part 21b derives the error rate err in the manner mentioned above, the distortion deriving part 21c next derives the actual data 24b (the dashed-dotted line curve in FIG. 10) representing the actual distortion characteristic of the target camera 5, based on the derived error rate err and the design data 24a (the solid-line curve in FIG. 10) (a step S31). The actual image height r′ can be derived by a following mathematical formula 10 created by modifying the mathematical formula 1, based on the design image height r represented by the design data 24a.

$${r}^{′} = ( 1 + \frac{err}{100} ) r \qquad [ Mathematical formula 10 ]$$

As mentioned above, in the vehicle-mounted apparatus 2 in the embodiment, the position identifying part 21a identifies the positions P1 and P2 of the mark images 71a and 72a in the captured image GC obtained by capturing the two marks 71 and 72 by the camera 5 (the step S21). Then, the error rate deriving part 21b derives the error rate err of the actual image height r′ to the design image height r, based on the positions P1 and P2 of the two mark images 71a and 72a (the step S22 to the step S30). Moreover, the distortion deriving part 21c derives the actual distortion characteristic (the actual data 24b) of the camera 5 based on the error rate err and the design characteristic (the design data 24a) (a step S31).

Since the actual distortion characteristic of the camera 5 can be derived from the positions P1 and P2 of the two mark images 71a and 72a in the captured image GC, in the manner mentioned above, large equipment, for example, many marks arranged in a grid in a work area is not required to derives the actual distortion characteristic. Therefore, the actual distortion characteristic of the camera 5 can be derived with relatively simple equipment.

Moreover, the error rate deriving part 21b sets the temporary value to the error rate err and derives the derived distance M between the two marks 71 and 72 based on the temporary value for the error rate err and on the positions P1 and P2 of the two mark images 71a and 72a in the captured image GC. Then, the error rate deriving part 21b derives the actual error rate err based on the evaluation value E that is the result of the comparison between the derived distance M and the actual distance m between the two marks 71 and 72. Therefore, the actual distortion characteristic of the camera 5 can be derived by a relatively simple algorithm.

Furthermore, the parameter obtaining part 21d obtains the installation parameters relating to the installation of the camera 5, based on the actual distortion characteristic of the camera 5 and on the captured image GC obtained by capturing the two marks 71 and 72 by the camera 5. Since the actual distortion characteristic of the camera 5 is used to obtain the installation parameters as mentioned above, accurate installation parameters can be obtained.

In addition, the image combiner 23 generates the combined image showing the surroundings of the vehicle 9 viewed from a virtual viewpoint, using the captured image captured by each of the plurality of cameras 5 and the actual distortion characteristic of each of the plurality of cameras 5. Therefore, a large problem where images of a same subject are misaligned can be prevented and a combined image correctly and entirely showing the surroundings of the vehicle 9 can be generated.

<7. Modification>

The embodiment of the invention has been explained above. However, the invention is not limited to the embodiment explained above but various modifications are possible. Examples of the modifications are explained below. All forms including the aforementioned embodiment and the modifications explained below may be combined arbitrarily.

In the aforementioned embodiment, the position identifying part 21a identifies the positions P1 and P2 of the mark images 71a and 72a in the captured image GC by the arithmetic calculation. However, the position identifying part 21a may identify the positions P1 and P2 of the mark images 71a and 72a in the captured image GC, based on positions specified by a user (worker). In this case, the user specifies the positions P1 and P2 of the mark images 71a and 72a by, for example, a cursor, viewing the captured image GC displayed on the display 26.

Moreover, in the aforementioned embodiment, the mark 70 is formed on the position marker 7 that can stand upright. However, the mark 70 may be formed on a principle surface of a position marker that cannot stand upright or may be formed on a floor surface of a work area.

Furthermore, in the aforementioned embodiment, it is explained that each of the plurality of cameras 5 captures an image of the two marks 70. However, each of the plurality of cameras 5 may capture an image of three or more marks 70. In other words, each of the plurality of cameras 5 should capture an image of at least two marks 70.

In addition, in the aforementioned embodiment, it is explained that the various functions are implemented by arithmetic processing performed by the CPU in accordance with a program. However, a part of the functions may be implemented by an electrical hardware circuit. On the other hand, a part of the functions implemented by a hardware circuit in the aforementioned embodiment may be implemented by software.

While the invention has been shown and described in detail, the foregoing description is in all aspects illustrative and not restrictive. It is therefore understood that numerous other modifications and variations can be devised without departing from the scope of the invention.

What is claimed is:

1. A data deriving apparatus that derives data relating to a camera, the apparatus comprising:
a controller configured to:
identify positions of two mark images in a captured image of two marks obtained by the camera;
derive an error rate of an actual image height of a subject image in the captured image to a design image height based on a first distortion characteristic defined in advance from design of the camera, based on the positions of the two mark images; and
derive an actual second distortion characteristic of the camera, based on the error rate and the first distortion characteristic.

2. The data deriving apparatus according to claim 1, wherein
the controller derives the error rate based on a result of a comparison of an actual distance between the two marks with a derived distance between the two marks derived based on the positions of the two mark images in the captured image.

3. The data deriving apparatus according to claim 2, wherein
the controller obtains an installation parameter relating to installation of the camera, based on the second distortion characteristic and the captured image of the two marks obtained by the camera.

4. The data deriving apparatus according to claim 1, wherein
the data deriving apparatus derives the second distortion characteristic of each of a plurality of cameras installed on a vehicle, the data deriving apparatus further comprising
an image generator that generates a combined image showing surroundings of the vehicle viewed from a virtual point of view, using the captured images obtained by the plurality of cameras and the second distortion characteristics of the plurality of cameras.

5. A data deriving method that derives data relating to a camera, the method performed by a controller and comprising the steps of:
(a) identifying positions of two mark images in a captured image of two marks obtained by the camera;
(b) deriving an error rate of an actual image height of a subject in the captured image to a design image height based on a first distortion characteristic defined in advance from design of the camera, based on the positions of the two mark images; and
(c) deriving an actual second distortion characteristic of the camera, based on the error rate and the first distortion characteristic.

6. The data deriving method according to claim 5, wherein
the step (b) derives the error rate based on a result of a comparison of an actual distance between the two marks with a derived distance between the two marks derived based on the positions of the two mark images in the captured image.

7. The data deriving method according to claim 5, further comprising the step of
(d) obtaining an installation parameter relating to installation of the camera, based on the second distortion characteristic and the captured image of the two marks obtained by the camera.

8. The data deriving method according to claim 5, wherein
the data deriving method derives the second distortion characteristic of each of a plurality of cameras installed on a vehicle, the method further comprising the step of
generating a combined image showing surroundings of the vehicle viewed from a virtual point of view, using the captured images obtained by the plurality of cameras and the second distortion characteristics of the plurality of cameras.
